(19) United States
(12) Patent Application Publication
(10) Pub. No.: US 2010/0131762 A1
(43) Pub. Date: May 27, 2010

(54) SECURED COMMUNICATION METHOD FOR WIRELESS MESH NETWORK

(76) Inventors: YUE WU, (US); Donglai Sun, (US); Ping Yi, (US); Jianhua Li, (US)

Correspondence Address: Yue Wu;School of Information Security Eng., SJTU, 800 Dongchuan Road, Shanghai, 200240, omitted

(21) Appl. No.: 12/640,296

(22) Filed: Dec. 17, 2009

(51) Int. Cl. H04L 9/32; G06F 21/20

(52) U.S. Cl. 713/170; 380/270; 713/171

(57) ABSTRACT

A secured communication method for Wireless Mesh Network (WMN) in the field of network technology includes initial authentication request, authentication negotiation process of the authentication server and encrypted data communication via pre-shared key and other valid Mesh Point (MP) in the WMN in order to implement the functions of the WMN. The present invention not only meets the new needs of the WMN dynamic self-organization, but also provides the security performance almost the same as the IEEE 802.11 standard requirements. The present invention is easily applied into WMN upon IEEE 802.11 links, and furthermore, the architecture disclosed in the present invention is quite simple and easy to implement with full compatibility and flexibility.

### BACKGROUND OF THE INVENTION

1. Field of the Invention

This invention related to a method for the field of network technology, specifically a type of secured communication method for Wireless Mesh Network

2. Description of the Related Art

Wireless Mesh Network (WMN) is a multi-hop self-organized wireless communication architecture totally different from traditional wireless network. Within the traditional Wireless LAN (local area network), each client side can access to the network via a fixed wireless link connected with access point (AP), and each access point can access to the Internet via wired network. However, within a WMN, any Mesh Point (MP) works both as AP and backbone router at the same time. Some of the wireless nodes can access the Internet via wired network, while other nodes access the Internet via the multi-hop wireless link which is supported by the routing algorithm of the WMN. The user can move around within the signal coverage of the WMN, and access to the Internet via a random MP. The technology of the WMN has been widely adopted and applied to various areas, such as municipal administration, disaster recovery, security monitoring and control, industrial management, emergency medical treatment, etc. With regard to the main application areas, how to ensure the security of such WMN is one of the key issues concerning successful application of the technology.

The Technology of communication security is widely applied to the network. This technology is used to verify the identities of valid users, identify the permission rights for these valid users, and generate a set of security key schemes for keeping confidentiality and integrity of the transmission data in communication. Since within common wireless LAN, all wireless communications only occur between the user and access point, secured communication is only needed to ensure the security of the single wireless link. However, within the WMN, the access points of the mesh network are connected via multi-hop wireless links, which requires a whole set of technologies of communication security solutions.

In the current applications of the WMN, since simple mechanism such as WEP could no longer effectively ensure the security of the transmission data on the wireless network, or ensure the validity of accessed users, the IEEE (Institute of Electrical and Electronics Engineers) organization for standardization proposed the 802.11i supplementary proposal used to improve the security performance of the wireless LAN. The IEEE 802.11i standard provides a reliable solution to settle the security problem for users of wireless LAN, and presents an notion of RSN, the Robust Security Network. The RSN consists of two parts: security association management mechanism and data encryption mechanism. The security association management mechanism includes RSN security capability negotiation process, 802.1x authentication process and 802.1x key distribution process. By choosing the IEEE 802.1x upon the access control protocol of the port, 802.11i achieves the access control mode of the Supplicant, Authenticator and Authentication Server (AS). RSN, after security capability negotiation, 802.1x authentication, and 802.1x key distributions in sequence 4-time handshake, will generate the key for data communication. The data encryption mechanism of RSN consists of TKIP (Temporal Key Integrity Protocol) and CCMP (Counter mode with Cipher-block chaining Message authentication code Protocol). The above details provide references for the security design for the MP in WMN.

To comply with the features of the WMN, IEEE proposed a security solution named MSA (Mesh Security Association). Compared with the 802.11i solution, MSA applied a new security architecture, defined a series of different roles, and adopted a new set of authentication protocols to establish and operate this new architecture. The purpose of role definitions is to distinguish different objects of security authentication and encryption communication. The key issue to set up the architecture is to ensure the security by refining the roles for mesh network node and establishing branches and inter-layer segregation. Meanwhile, the new roles of the system MKD (Mesh Key Distributor), performs part of the functions of agent AS. Different keys are used for communications between different branches of MP and MA (Mesh Authenticator), or MKD and MA.

Upon further searching for current technology, there is a Chinese patent of “Wireless Network Authentication System and Authentication Encryption Methods” with application number of CN02155172, which includes one AS generating a random number, one authentication equipment recording the first random number, one terminal equipment connected with the authentication equipment and comprises of at least one wireless transmission device, such as AS and the terminal equipment inter-communicates by using such wireless transmission device. When the terminal user intends to obtain authentication, such terminal equipment will send one request of authentication as well as one user name to such AS and one authentication database which is connected with AS and could record the first random number. The above mentioned method for wireless network authentication and encryption is achieved merely by adopting simple handshake protocol process and server authentication method, and is not suitable for WMN of this invention. First of all, from the perspective of security, the prior art only uses exchange of random number to achieve authentication. However, the data packet is easily repeated and have replay attacks so as to enter into the server's confidence and illegally obtain the key to access the network. Secondly, from the perspective of the needs of equipments, the art lacks of necessary technology of communication encryption to keep wireless data of the entire network from theft which is not suitable for the WMN. Thirdly, since the WMN is a multi-hop wireless network, we need to maintain a data link encrypted as the same during the authentication process and service period, so as to secure encryption application from peeping and replay attacks. Therefore, the prior art could not satisfy the technological needs of WMN for security authentication and encrypted communication.

### SUMMARY OF INVENTION

The present invention, aiming at solving the above mentioned shortcomings of current technology, is to provide a secured solution for WMN (wireless mesh network) by distinguishing the roles of MP (mesh point) and designing the security authentication process and encryption communication method so as to meet the requirements for secured communication between MPs.

The present invention is achieved by the disclosed technology with the following steps:

The first step is that, all valid existing MP can use a current pre-shared key to encrypt all the transmission data over the wireless channel. When the candidate MP sends an initial authentication request to the nearest valid MP, the aforementioned valid MP will send the initial authentication request from the aforementioned candidate MP to the AS (authentication server) via links of a WMN so as to initiate the process of initial authentication negotiation.

The aforementioned MP refers to the node capable of communicating with other mesh network node. All the nodes, after passing the authentication by the aforementioned AS will become valid MPs, which can send and receive data packets within the network, and forward authentication request from the candidate node.

The aforementioned pre-shared key refers to a set of characters used for WMN encryption of transmission data over the wireless channel. The characters are shared among all valid MPs, as set forth above, and will be refreshed by Mesh key distribution nodes in mesh network after a certain period of time.

The aforementioned encryption refers to using a pre-shared key, as set forth above, and adopts the same encryption algorithm for data packets, and all cryptography cannot be paraphrased into plaintext by a third party without the key.

The aforementioned encryption algorithm refers to Data Encryption Standard (DES) algorithm.

The aforementioned candidate MP refers to the MP expecting to join the current WMN, and this aforementioned MP after passing the authentication by the aforementioned AS will become valid MP, as set forth above.

The aforementioned WMN link refers to wireless data link between aforementioned valid MP and the aforementioned AS, which is separated from WMN encryption data link.

The aforementioned AS refers to the server of the WMN connected to the exit point of the Internet, which is connected through a fixed cable with key distribution nodes in the mesh network and responsible for all candidate MPs, as set forth above, to start the process of the initial authentication negotiation.

The second step is that, the aforementioned AS starts the process of the initial authentication negotiation. After the candidate MP, as set forth above, sending an authentication request to the aforementioned AS via the aforementioned valid MP of the first step, the aforementioned AS will process the request so as to decide whether the candidate node can join the network or not.

The aforementioned authentication request includes the address of the candidate MP, as set forth above, the key pending for authentication and the exchange information of the key. Such authentication request will be encrypted by the default key within the aforementioned AS and any other refinement with no changes to its functions.

The aforementioned process of authentication request refers to matching of identity information from back-end database and the identity information from the request so as to determine whether the candidate MP, as set forth above, has used a valid identity to joint the WMN or not.

Upon accomplishment of the process of the aforementioned authentication request, exchange of key between the aforementioned AS and the aforementioned candidate MP occurs, and the aforementioned pre-shared key is distributed to the aforementioned candidate MP via the key distribution node in mesh network, and then goes to the third step.

When the process of authentication request, as set forth above, is not accomplished, the aforementioned candidate MPs can not join the WMN and can not obtain the encryption method and the key of the current network which leads to a failure of secured communication.

The aforementioned key exchange refers to the public security settings protocol established before data exchange between the aforementioned AS and the aforementioned candidate MPs, which is used for secured exchange of a set of keys.

The aforementioned key is merely accessed by the aforementioned AS and the aforementioned candidate nodes, all transmission data is used for encryption by such key, as set forth above, and the valid mesh network nodes for transmitting the data have no access to any knowledge of such key.

The aforementioned key distribution node of mesh network refers to the node responsible for WMN key distribution and management, which is connected to the aforementioned AS via secured path.

The aforementioned key distribution nodes of mesh network periodically send updated pre-shared key, as set forth above, to all valid WMN nodes via secure links.

The third step is that, the aforementioned candidate MPs process encrypted data communication through the aforementioned pre-shared key with other valid MPs, as set forth above, so as to perform the function of WMN.

The present invention not only meets the new needs of the WMN dynamic self-organization, but also provides the security performance almost the same as the 802.11 standard requirements. The present invention is improved upon the wireless communication standards of the 802.11 protocols, which is easily applied into WMN established upon 802.11 links. The frame and structure disclosed by the present invention is quite simple, easy to achieve, and also ensures compatibility and flexibility.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows the methodology of the present invention.

Like reference numerals refer to like parts throughout the several views of the drawings.

### DESCRIPTION OF THE PREFERRED EMBODIMENT

The detailed illustration for the embodiment of the invention is shown below. The embodiment is performed according to the technological plan of the invention, with detailed scheme and specific operational process.

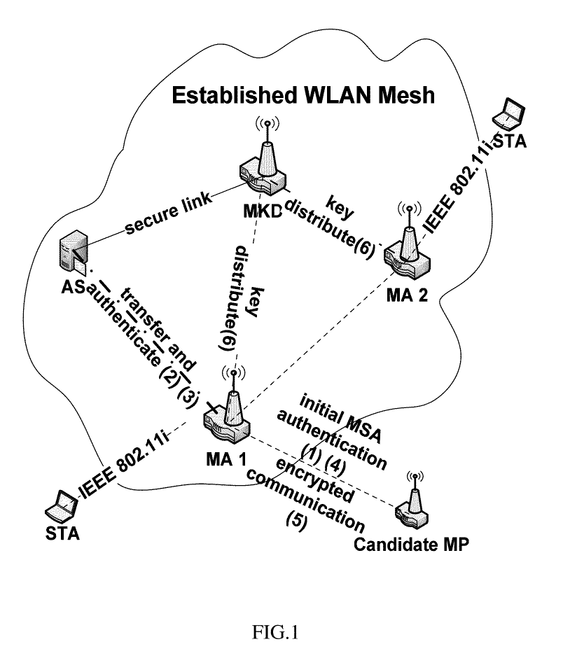

As shown in FIG. 1, the embodiment shall take the following steps.

1) All valid MPs (mesh points) in a WMN (wireless mesh network), including multiple MPs and key distribution nodes of mesh network, can jointly use a current pre-shared key to encrypt all the transmission data in the wireless tunnel. Meanwhile, MPs in the network can ensure effective connection between all nodes and the Internet via self-organization.

2) A Candidate MP wishes to join the WMN but has no valid identity in its network, nor can access to the current shared key in the network. Therefore, it sends initial authentication request to the nearest valid MP, as set forth above, and initiate the process of authentication negotiation (1). The initial authentication requests to use a basic shared key for encryption to ensure the security of request.

3) The aforementioned valid MP in the WMN will forward the request from the aforementioned candidate MP to the AS (authentication server) via a wireless data link logically segregated from the WMN encrypted data link. The aforementioned AS will process the request upon receiving the authentication request from the aforementioned candidate MP (2).

4) If the step 3) fails, the aforementioned candidate MP can not joint the WMN, and can not obtain the communication encryption methods and key of the current network. The information of authentication failure will be sent to the aforementioned candidate MP and such aforementioned MP may not send the request for authentication again within a short period of time.

5) The aforementioned Valid MP of the WMN will continuously maintain communication forwarded from the wireless link segregated from WMN encrypted data link to the aforementioned AS and the aforementioned candidate MP, until a definite success or failure of the initial authentication protocol (3).

6) When the aforementioned AS passes the aforementioned candidate MP authentication request as stated in the step (3), the aforementioned AS and the aforementioned candidate MP will have communication handshake, and complete one key exchange process. And then, the public key generated from the key exchange will protect the initial authentication protocol to be completed by the aforementioned AS and the aforementioned candidate MP, so that the aforementioned candidate MP may become a valid MP (4), as set forth above.

7) After the aforementioned candidate MP obtains the pre-shared key of the network, it will use the key to process encrypted data communication, with other MPs, as set forth above, and the aforementioned candidate MP will become a valid MP, as set forth above. The key will be used to protect the data communication of the WMN (5).

8) In order to ensure the security of the network, key distribution node of the mesh network will update a new pre-shared key to the network. Before such key distribution, the key distribution node will have a key exchange with all valid MPs, as set forth above, and use a couple of public key and private key to encrypt the communication of key distribution process. All aforementioned valid MPs will receive a new pre-shared key via a private encrypted link (6), which may be used for encrypted communication of the WMN.

The secured communication method for wireless mesh network of the present invention is not meant to be limited to the aforementioned security architecture, and the subsequent specific description utilization and explanation of certain characteristics previously recited as being characteristics of this security architecture are not intended to be limited to such technology.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A secured communication method for wireless mesh network, said method comprising:
Step one: All valid existing MP (mesh point) of the WMN (wireless mesh network) using a current pre-shared key to process the encryption of all transmission data over the wireless tunnel, and when the candidate MP sending a request to the nearest said valid MP neighboring to it, said valid MP forwarding the initial authentication request from said candidate MP to the AS (authentication server) via the link of the WMN so as to initiate the initial authentication protocol process,
Step two: Said candidate MP starting the process of the initial authentication negotiation by sending an authentication request to said AS via said valid MP of the first step and then said AS processing the request so as to decide whether the candidate node can join the network or not, and
Step three: Said candidate MP processing encrypted data communication with other said valid MP by using pre-shared key so as to perform the function of WMN.

2. A method as recited in claim 1 wherein said pre-shared key of step one refers to a set of characters used for WMN encryption of transmission data over the wireless channel, and said characters are shared among all said valid MPs, and will be refreshed by key distribution nodes of mesh network periodically.

3. A method as recited in claim 1 wherein said candidate MP of step one refers to a MP expecting to join the current WMN, and such said MP after passing the authentication by said AS will become a said valid MP.

4. A method as recited in claim 1 wherein said WMN link of step one refers to the wireless data link between said valid MP and said AS which is separated from WMN encryption data link.

5. A method as recited in claim 1 wherein said authentication request information of step two includes the address of said candidate MP, the key pending for authentication and the exchange information of said key, and said authentication request will encrypt via the default key within said AS.

6. A method as recited in claim 1 wherein said authentication process further comprising:
a) Said process of authentication in step two referring to a check of matching of identity information from back-end database and the identity information from the request so as to determine whether said candidate MP has used a valid identity to joint the WMN,
b) Upon accomplishing of said process of authentication request, exchange of key between said AS and said candidate MP occurring, and pre-shared key being distributed to said candidate MP via the key distribution node in mesh network, and then coming to next step, and
c) When said process of authentication request not being accomplished, said candidate MPs unable to join the WMN and obtain the encryption method and the key of the current network leading to a failure of secured communication.

7. A method as recited in claim 1 wherein said key exchange in step two refers to the public security settings protocol established before data exchange between said AS and said candidate MPs used for security exchange of a set of keys.

8. A method as recited in claim 1 wherein in step two, said key is merely accessed by said AS and the candidate nodes, and all transmission data is used for encryption by such said key, and the valid mesh network nodes for transmitting the data have no access to any knowledge of such said key.

9. A method as recited in claim 1 wherein in step two, said key distribution node of mesh network refers to the node responsible for WMN key distribution and management connected to said AS via secure path.

10. A method as recited in claim 1 wherein in step two, said key distribution nodes of mesh network periodically sends updated said pre-shared key to all said valid WMN nodes via secure links.
